(19) United States
(12) Patent Application Publication
(10) Pub. No.: US 2022/0361490 A1
(43) Pub. Date: Nov. 17, 2022

(54) SEED COATING COMPOSITIONS

(71) Applicant: CORN PRODUCTS DEVELOPMENT, INC., Westchester, IL (US)

(72) Inventors: Gulam AHMED, Bridgewater, NJ (US); Wendell RICH, Bridgewater, NJ (US); Himanshu SHAH, Bridgewater, NJ (US)

(21) Appl. No.: 17/763,010

(22) PCT Filed: Sep. 15, 2020
(86) PCT No.: PCT/US2020/050807

§ 371 Date: Mar. 23, 2022

Related U.S. Application Data
(60) Provisional application No. 62/907,407, filed on Sep. 27, 2019.

(51) Int. Cl. A01N 27/00; A01C 1/06; A01N 51/00; A01P 3/00

(52) U.S. Cl. CPC A01N 27/00; A01C 1/06; A01N 51/00; A01P 3/00

(57) ABSTRACT

Disclosed herein is one or more aqueous seed coating composition comprising (i) a binder comprising a modified starch, and (ii) an active ingredient, which composition works at least as well as or better than an aqueous seed coating composition containing a synthetic polymer, and, surprisingly, better than aqueous seed coating compositions containing unmodified starch. The binder comprising a modified starch is water soluble, compatible with the active ingredients, and more cost effective than using primarily synthetic polymers as the binder in an aqueous seed coating composition. Additionally, the one or more aqueous seed coating compositions described herein provide excellent seed coating characteristics, including demonstrating good flowability, decreased dust-off, and uniform coating application.

Disclosed herein is one or more aqueous seed coating composition comprising (i) a binder comprising a modified starch, and (ii) an active ingredient, which composition works at least as well as or better than an aqueous seed coating composition containing a synthetic polymer, and, surprisingly, better than aqueous seed coating compositions containing unmodified starch. The binder comprising a modified starch is water soluble, compatible with the active ingredients, and more cost effective than using primarily synthetic polymers as the binder in an aqueous seed coating composition. Additionally, the one or more aqueous seed coating compositions described herein provide excellent seed coating characteristics, including demonstrating good flowability, decreased dust-off, and uniform coating application.

Agricultural farmers are always looking to improve crop yields to address the increasing demand for food. One approach used by the agricultural industry to boost crop yields is seed treatment (seed coating), where the seeds are treated/coated with one or more active ingredients, including, e.g., insecticides, fungicides, nematicides, nutrients, plant growth hormones, and beneficial microbes to protect the seeds once planted from disease, fungi and/or insects. During the seed coating process, the active ingredient slurry is added on the surface of the seed using seed coating binders. These seed coatings enable the one or more active ingredients to be delivered to the seed or seedling during germination to provide a healthy root mass for excellent emergence and vigor for the growing crops, thereby resulting in higher crop yields. An important advantage of delivering the one or more active ingredients through a seed coating is that the seed coating allows for a precise and controlled release dose of the one or more active ingredients to each individual seedling.

The seed coating also protects the seeds from damage during handling, thereby improving the seed handling properties. For example, coated seeds are typically subjected to contact with other objects and surfaces, as well as to each other. This may result in seed coating rub-off (dust-off). Rubbing-off refers to the transfer of parts of the coating from the coated seed to a surface of a non-seed object, such as, e.g., seed bags, seed containers and seed handling equipment. Rubbing-off may result in loss of active ingredients in the form of dust (dust-off). In case of coated seed that is planted or sown by workers, rubbing-off in the form of dust-off may give rise to health and safety concerns. Moreover, seed coatings exhibiting rubbing-off tend to be sticky, increasing risk of imprecise planting and the blockage of seed-planter equipment. Additionally, by minimizing the rub-off (dust-off) the coated seed products have improved visual appearance.

The most widely used aqueous seed coating compositions in the agricultural industry contain natural or synthetic polymeric materials as the binder, where polymer blends, such as, e.g., polyvinyl alcohol, polyvinylpyrrolidones, polyvinyl acetate, and like are the most commonly used binders or coating materials. Seed coating compositions containing polymer-based materials as the binder have limited biodegradability, contributing to microplastic environmental pollution. As a result, there remains a need for bio-degradable, bio-based, and bio-renewable aqueous seed coating compositions that are cost effective, better for the environment than the widely used aqueous seed coating compositions containing synthetic polymers, and that perform at least as well as the less environmentally friendly seed coating compositions containing synthetic polymeric materials.

Disclosed herein is one or more aqueous seed coating composition comprising (i) a binder comprising a modified starch, and (ii) an active ingredient. Surprisingly, the one or more aqueous seed coating composition described herein performs better than an aqueous seed coating composition containing a non-modified starch versus a modified starch as the seed coating binder. Moreover, the modified starch works at least as well as traditional synthetic polymers and may be used in combination with, or in lieu of, a synthetic polymer to provide an aqueous seed coating composition. Also, disclosed herein is use of the aqueous seed coating compositions described herein to coat seeds. Further disclosed herein is a coated seed comprising one or more aqueous seed coating composition described herein. Even further disclosed herein is a method for coating one or more seeds, comprising (i) admixing a binder comprising a modified starch with an active ingredient to form an aqueous seed coating composition; and (ii) applying said composition to one or more seed.

In one embodiment, the one or more aqueous seed coating compositions comprise a binder comprising one or more modified starches comprising any native starch containing amylose, amylopectin or any combination thereof (e.g., dent starch) that is chemically, enzymatically, or physically modified. In some embodiments, the one or more modified starch contained in the one or more aqueous seed coating compositions described herein is selected from, for example, crosslinked starches; acetylated and similar esterified starches; ethylated starches (such as, e.g., hydroxyethylated and hydroxypropylated starches); phosphorylated starches; cationic, anionic, nonionic, and zwitterionic starches, dextrins and modified dextrins, and succinate and substituted succinate derivatives of starch. Procedures for modifying starches are well-known and described, for example, in Modified Starches: Properties and Uses, Ed. Wurzburg, CRC Press, Inc., Florida (1986).

In another embodiment, the one or more aqueous seed coating compositions described herein are free from synthetic or traditional seed coating polymers. In still other embodiments, the one or more aqueous seed coating compositions described herein comprise a binder comprising one or more modified starch and one or more synthetic seed coating polymer. In yet still other embodiments, the one or more aqueous seed coating compositions contain less of the one or more synthetic seed coating polymer than the one or more modified starch. In even further embodiments, the one or more aqueous seed coating composition described herein further comprises additional additives such as but not limited to additional binders, fillers, nutrients, wetting and dispersing additives (sometimes also referred to as pigment dispersant), solvents, plasticizers, emulsifiers, thickeners, coloring agents, anti-foaming agents, biocides, surfactants and/or pigments.

The aqueous seed coating compositions described herein can be prepared by blending the various ingredients together or can be added separately during the seed coating process.

In still another embodiment, the one or more aqueous seed coating compositions described herein further comprises one or more active ingredients. In a further embodiment, the one or more active ingredient is a pesticide, a plant growth regulator, a crop desiccant, a fungicide, a bactericide, a bacteriostat, an insecticide, a nematicide, an insect repellant, a triazine, a sulfonylurea, a uracil, a urea, an acetanilide, an organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, an acylamine fungicide, a chlorinated aromatic dichloro aniline fungicide, a carbamate insecticide, an organo thiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, a fertilizer, or any combination thereof. In still another embodiment, the one or more active ingredient is a bio-pesticide from a plant or microbial origin or biological live beneficial microbe from a bacterial or fungal genera.

Yet another embodiment described herein is directed to one or more method for preparing a coated seed comprising providing one or more seed, providing one or more aqueous seed coating composition comprising a binder comprising one or more modified starch, and contacting the aqueous coating composition with the seed to coat all or a portion of the seed.

Further disclosed herein are compositions and methods related to seedling establishment, to improve yield of crops, as well as agricultural and horticultural plants, shrubs, trees, grasses and the like. In one embodiment, the compositions and methods described herein related to prevention of agricultural compounds, such as pesticides, fertilizers, herbicides, and the like, lost to water runoff or drainage (wherein when lost to runoff or drainage, such agricultural compounds are not available for grass and plants and the like).

### BRIEF DESCRIPTION OF THE FIGURES

FIGS. 1A and 1B display two graphs showing the results of the tests measuring dust-off levels for corn seeds coated with seed compositions containing modified starch (OSA modified starch (samples 3 and 10), PO modified starch (samples 4 and 11) and cationic starch (sample 9)) compared to corn seeds coated with seed compositions containing synthetic polymers (samples 2 and 8) or unmodified starch (corn starch, samples 5, 6, and 12), and untreated seed (samples 1 and 7). The seed coating compositions also contained a blend of active ingredients. FIG. 1A shows the results for one variety of corn seeds (samples 1-6) and FIG. 1B shows the results for another variety of corn seeds (samples 7-12). Both figures show that modified starches provided seed coating compositions with dust-off amounts comparable to or lower than that provided by synthetic polymers, and that modified starches provided dust-off amounts significantly lower than that provided by un-modified starches.

FIG. 2 displays a schematic diagram of the flowability funnel used for testing in Example 2.

FIG. 3 displays a graph showing the results of the flowability testing of corn seeds coated with aqueous seed coating composition containing synthetic polymer (sample 8), or modified starches such as sample 9 (cationic modified starch), sample 10 (OSA modified starch), and sample 11 (PO modified starch)). Flowability data of seeds coated with coatings containing modified starches showed significantly better seed flowability than seeds coated with an aqueous seed coating composition containing un-modified corn starch (sample 12). The seed coating compositions also contained a blend of active ingredients.

FIGS. 4A and 4B display two graphs showing the plantability of corn seeds coated with an aqueous seed coating composition containing modified starches such as sample 9 (cationic modified starch), samples 3 and 10 (OSA modified starch), and samples 4 and 11 (PO modified starch). Samples 1 and 7 are un-coated seeds. Samples 2 and 8 shows plantability data of seeds coated with synthetic polymers. The seed coating compositions also contained a blend of active ingredients. FIG. 4A shows the results for one variety of corn seeds (samples 1-6) and FIG. 4B shows the results for another variety of corn seeds (samples 7-12). The figures show that all samples provided similar % singulation. Modified starches provided seed coating compositions having plantability comparable to that provided by synthetic polymers and modified starches.

FIG. 5 displays a graph showing the results of the tests measuring dust-off levels for soy seeds coated with a seed coating composition containing a synthetic polymer (sample 13), compared to soy seeds coated with aqueous seed coating compositions containing modified starch, such as sample 14 (OSA modified starch), sample 15 (PO modified starch), and sample 16 (a blend of OSA and PO modified starches) and soy seeds coated with seed coating compositions containing a blend of OSA and PO modified starches and a plasticizer (sample 17). The seed coating compositions also contained a blend of active ingredients. The figure shows that modified starches provided seed coatings with dust-off amounts at least comparable to or that provided by a synthetic polymer.

FIG. 6 displays a graph showing the plantability of soy seeds coated with a seed coating composition containing synthetic polymers (sample 13), OSA modified starch (sample 14), PO modified starch (sample 15), a blend of OSA and PO modified starches (sample 16) and a blend of OSA and PO modified starches and a plasticizer (sample 17). The seed coating compositions also contained a blend of active ingredients. The figure shows that modified starches provided seed coating compositions having plantability (% singulation) comparable to that provided by synthetic polymers.

FIG. 7 displays a graph showing the results of the tests for dust-off levels for corn seeds coated with aqueous seed compositions containing modified starches and plasticizers (samples 18-22) versus synthetic polymers (sample 23). The seed coating compositions also contained a blend of active ingredients.

FIG. 8 displays a graph showing the plantability of corn seeds coated with aqueous seed coating compositions containing modified starches and plasticizers (samples 18-22) or synthetic polymer (sample 23) versus un-coated corn seeds (sample 24). The seed coating compositions also contained a blend of active ingredients. The figure shows that certain combinations of modified starches and plasticizers provided seed coating compositions providing plantability (% singulation) superior to that provided by synthetic polymers.

Numerous specific details are set forth herein to provide a thorough understanding of various embodiments of the present invention. However, unless otherwise indicated or implicit from context, these details are intended to be examples and should not be deemed to limit the scope of the invention in any way. Additionally, features described in connection with various or specific embodiments are not to be construed as not appropriate for use in connection with other embodiments disclosed herein unless such exclusivity is explicitly stated or implicit from context.

All terminology used herein is for the purpose of describing particular embodiments only and is not intended to be limiting in any manner or scope. For example, as used in this specification and the appended claims, the singular forms “a,” “an” and “the” can include plurals unless the context clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation. In describing and claiming the embodiments, the following terminology will be used in accordance with the definitions set out below.

The term “seed” as used in this application is meant to refer in particular to the ripened ovule of gymnosperms and angiosperms, which contains an embryo surrounded by a protective cover. The protective cover can comprise the seed coat (testa). Some seeds comprise a pericarp or fruit coat around the seed coat. In particular, when this layer is closely adhered to the seed, as in cereal kernels, it is in some cases referred to as a caryopsis or an achene.

In practical terms, the term “seed” includes but is not restricted to anything that can be planted in agriculture to produce plants, including pelleted seeds, true seeds, plant seedlings, rootstock, regenerable and plant forming tissue, and tubers or bulbs.

The term “coating” as used in this application, is meant to refer to applying material to a surface of a seed, for instance as a layer of a material around a seed. Coating includes film coating, pelleting, and encrusting or a combination of these techniques. Pellets obtained with pelleting are also known as seed pills. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed coating composition” as used in this application is meant to refer to an aqueous composition to be used for coating of seed.

The term “pre-blend” as used in this application is meant to refer to an aqueous composition, which is formed prior to adding the other components of the aqueous seed coating composition, i.e. is in a stable emulsion and/or dispersion form. The pre-blend is preferably formed in a different location to the aqueous seed coating composition.

The term “active” as used in this application is meant to refer to any component that is directly or indirectly advantageous for a plant or a plant seed, for instance through a biological effect on the plant, seed, or on organisms harmful for a plant such as fungi, pests and insects. Plant enhancing agents include plant protective products, safeners, growth promoters, growth regulators, and the like.

The term “hydrophobic and/or water insoluble” as used in this application is meant to describe materials that are primarily non-polar, and exhibit limited or no dissolution in water. However, such materials can be suspended in water as molecules or particles.

The term “alkoxy” means an-OR radical or group, where R is alkyl as defined above, e.g., methoxy, ethoxy, propoxy, or 2-propoxy, n-, iso-, or tert-butoxy, and the like. In certain embodiments, preferred alkoxy groups of the invention have 1 to 6 carbon atoms. In other embodiments, preferred alkoxy groups of the invention have three or more carbon atoms, preferably 4 to 6 carbon atoms. An alkoxy group may be optionally substituted where allowed by available valences. Examples of substituted alkoxy groups include trifluoromethoxy, hydroxymethyl, hydroxyethyl, hydroxypropyl, and alkoxyalkyl groups such as methoxymethyl, methoxyethyl, polyoxoethylene, polyoxopropylene, and similar groups. Unless specifically stated as “unsubstituted,” references to chemical moieties herein are understood to include substituted variants.

The term “alkyl” means a saturated straight chain or branched hydrocarbon chains having, for example, 1 to 20 carbon atoms. In some embodiments, the alkyl groups comprise “C1 to C6 alkyl” groups (alternatively termed “lower alkyl” groups) that include methyl, ethyl, propyl, iso-propyl n-butyl, iso-butyl, sec-butyl, t-butyl, pentyl, n-pentyl, tert-pentyl, neo-pentyl, iso-penthyl, 2-methylpentyl, 3-methylpentyl, 4-methylpentyl, 2,3-dimethylbutyl, hexyl, n-hexyl, tert-hexyl, neo-hexyl, iso-hexyl, sec-hexyl, and the like. In certain embodiments, preferred alkyl groups of the invention have 1 to 6 carbon atoms. In certain embodiments, preferred alkyl groups of the invention have three or more carbon atoms, preferably 4 to 6 carbon atoms. An alkyl group may be optionally substituted where allowed by available valences. Unless specifically stated as “unsubstituted,” references to chemical moieties herein are understood to include substituted variants.

The terms “combination” or “combinations” refer to a mixture of two or more compounds (or other referenced components). Combinations can include, but are not limited to, a combination of one or more compounds of Formula (I) or biologically acceptable salts, derivatives, diastereomers, or enantiomers thereof, or one or more additional sweeteners.

As used herein, the term “free,” “no,” “substantially no” or “substantially free” refers to a composition, mixture, or ingredient that does not contain a particular compound or to which a particular compound or a particular compound-containing compound has not been added. Should the particular compound be present through contamination and/or use in a minimal amount of a composition, mixture, or ingredients, the amount of the compound shall be less than about 3 wt. %. More preferably, the amount of the compound is less than 2 wt. %, less than 1 wt. %, and most preferably the amount of the compound is less than 0.5 wt. % or 0.0 wt. %.

As used herein, unless otherwise specified, the term “substituted” means a group may be substituted by one or more independent substituents, examples of which include, but are not limited to, halo, alkyl, alkoxy, trifluoromethyl, trifluoromethoxy, hydroxy, alkoxy, cycloalkyoxy, heterocylooxy, oxo, alkanoyl, alkylcarbonyl, cycloalkyl, aryl, aryloxy, aralkyl, alkanoyloxy, cyano, azido, amino, alkylamino, —S(O)20H, arylamino, aralkylamino, cycloalkylamino, heterocycloamino, mono and disubstituted amino in which the two substituents on the amino group are selected from alkyl, aryl, aralkyl, alkanoylamino, aroylamino, aralkanoylamino, substituted alkanoylamino, substituted arylamino, substituted aralkanoylamino, thiol, alkylthio, arylthio, aralkylthio, cycloalkylthio, heterocyclothio, alkylthiono, arylthiono, aralkylthiono, alkyl sulfonyl, arylsulfonyl, aralkyl sulfonyl, oxygen, sulfonamido (e.g., —S02NH2), substituted sulfonamido, nitro, carboxy, carbamyl (e.g., —CONH2), substituted carbamyl (e.g., —CONH alkyl, —CONH aryl, —CONH aralkyl or instances where there are two substituents on the nitrogen selected from alkyl, aryl or aralkyl), alkoxycarbonyl, aryl, substituted aryl, guanidino and heterocyclo, such as indolyl, imidazolyl, furyl, thienyl, thiazolyl, pyrrolidyl, pyridyl, pyrimidyl, and the like.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Modified Starch

Starches normally have good thickening properties because of their high molecular weight polymeric components. For applications that typically utilize a high starch (i.e., solids) content, such as adhesives, candies and food coatings, the common practice is to use starches that have been modified. The modification process results in starch products with altered physical or chemical properties, examples of which include, but are not limited to, water dispersibility, lower or higher viscosity, shear resistance, freeze/thaw stability, anionic or cationic charge, viscosity stability in storage, and hydrophobic or lipophilic behavior. Modified starches can also be converted by chemical, enzymatic or physical means to reduce the molecular weight of the starch molecules and exhibit reduced viscosity. Likewise, modified starches can also be transformed to water dispersible or water-soluble states by additional chemical, enzymatic, thermal and physical means, meaning the final product will not require cooking to create a dispersed paste. These treatments are often called pregelatinization and common treatments include, but are not limited to, extrusion, drum drying or spray drying of slurries. Modified starches can also be pasted and provided as a ready to use liquid solution or dispersion, or modified by a dextrinization process, in which they could be referred to as dextrins. Dextrins as a group represent various levels of modification resulting in different levels of solubility, molecular weight, viscosity, color, and solution stability. Different dextrin classifications include white dextrins (low conversion, low solubility, and poor solution stability) and canary dextrins (high conversion, very high solubility, and high solution stability).

In some embodiments, the modified starch is provided in powder form. In other embodiments, the modified starch is provided in a liquid form. When modified starches are provided as part of an aqueous coating or in liquid form, they need to have high solution stability. Solution stable materials do not have significant precipitation, gelling, increased viscosity, or change in composition or texture during extended storage. Storage on ready to use liquids is typically measured in months and solution stable materials will have stability for several months at a minimum. In one embodiment, the aqueous coating starch binder will be stable for 6-12 months. Modifications which promote solution stability are necessary for most starches provided as ready to use liquids, and these include esters, ethers, and other branching modifications. Certain base starches also improve solution stability, such as waxy or pure amylopectin starch. In the case of dextrins, only canary dextrins would provide the solubility and solution stability necessary for ready to use liquids, as white dextrins would not provide adequate stability without additional chemical derivatization. Likewise, unmodified starches lack water solubility and solution stability.

All starches and flours (hereinafter “starch”) may be suitable for use as the base starch herein and may be derived from any native source. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starches derived from a plant grown from artificial mutations and variations of the above generic composition which may be produced by known standard methods of mutation breeding are also suitable for use as the base starch herein.

Typical sources for the base starches are cereals, tubers, roots, legumes and fruits. The native source can be corn, pea, potato, sweet potato, banana, barley, wheat, rice, sago, amaranth, tapioca, arrowroot, canna, sorghum, and waxy or high amylose varieties thereof. As used herein, the term “waxy” is intended to include a starch or flour containing at least about 95% by weight amylopectin and the term “high amylose” is intended to include a starch or flour containing at least about 30% by weight amylose.

Modified starch is defined as native starch containing amylose, amylopectin or combination of both (dent starch) which are modified using chemical, enzymatic or physical modifications. The examples of modified starch using either chemical, enzymatic or physical modifications are from the following categories but not limited to: Oxidized (using any oxidizing agent to add carbonyl or carboxyl groups to the starch), phosphate (monophosphate anionic or diphosphate crosslinked), other crosslinked (adipate, epichlorohydrin), Esterified (acetylated, succinated such as OSA octenyl succinate with or without aluminum salt), Etherified (ethylated, propylated, carboxymethyl or cationic) and combinations such as cationic and anionic (amphoteric) or crosslinked propylated. Starches can also by hydrolyzed by acid, enzyme or oxidant to reduce molecular weight, and can also have different base chemistry or structure from source materials (waxy, 100% amylopectin, naturally anionic phosphate, etc). Starches can also be dextrinized (dry roasted under acidic conditions) or pregelatinized (warm or cold water dispersible).

Some of the examples of the modified starches are acid hydrolyzed-2-hydroxypropyl ether, dextrinized hydrogen octenyl butanedioate, acetate hexadioate, 2-hydroxyl-3-(trimethylammonio)propyl ether chloride. In some embodiments the modified starch is not a cationic modified starch.

The most common conversion methods used in the starch industry include acid hydrolysis, oxidation, pyroconversion, and enzyme conversion. Except for enzyme conversion, granular starch is used in the modification processes for ease of recovery. This recovery process generally involves a suspension of the final starch product in water, neutralizing the pH, then filtering out the starch product and washing the product with water. Such a process generally removes salts and charged particles, including the smaller molecular weight side products created during conversion.

The use of aqueous methods to modify and convert starch which utilize the above described recovery method are well-known and described, for example, in publications such as “Starch: Chemistry and Technology”, Second Edition, edited by Roy L. Whistler et al., Chapter X; Starch Derivatives: Production and Uses by M. W. Rutenberg et al., Academic Press, Inc. 1984.

Modified starch components are renewable source and excellent for the environment compared to synthetic binders. As more and more “active ingredients” are added on the seeds, more polymer blends must be added to the seed coating mixture. Currently, in the seed coating industry, synthetic polymeric binders are used to coat insecticides, fungicides, nutrients and other active ingredients. The modified starch contained in the aqueous seed coating compositions described herein provide coatings having smooth uniform coverage of the “active ingredients” with no tackiness. After coated seeds are planted, the modified starch will also provide a food source to the beneficial microbes coated on the surface of the seed to speed the colonization of microbes on the roots. So, starch could provide a dual function as both coating material and food source for beneficial microbes.

### Seed Coating Compositions

Some embodiments are directed to an aqueous seed coating composition comprising: a binder comprising a modified starch and an active ingredient. In some embodiments, the aqueous seed coating compositions described herein comprise a binder comprising a modified starch, an active ingredient, and one or more additional component selected from a second binder, a filler, a nutrient, a wetting and dispersing additive or a pigment dispersant, a solvent, a plasticizer, an emulsifier, a thickener, a coloring agent or pigment, an anti-foaming agent, a biocide, a surfactant, mica, titanium dioxide, or any combination thereof.

### Binders

In some embodiments, the aqueous seed coating compositions described herein comprises an aqueous seed coating binder comprising one or more modified starch. In another embodiment, modified starch in the aqueous seed coating binder comprises from about 2 wt. % to about 70 wt. % solid starch. In still other embodiments, the modified starch in the aqueous seed coating binder comprises from about 10 wt. % to about 50 wt. % solid starch.

In some embodiments, the aqueous seed coating compositions described herein comprise from of about 1 wt. % to about 99 wt. % of the binder, based on the weight of the seed coating composition, or from about 1 wt. % to about 90 wt. %, 1 wt. % to about 80 wt. %, 1 wt. % to about 70 wt. %, 1 wt. % to about 60 wt. %, 1 wt. % to about 50 wt. %, 1 wt. % to about 40 wt. %, 1 wt. % to about 30 wt. %, 1 wt. % to about 20 wt. %, or 1 wt. % to about 10 wt. % of the binder, based on the weight of the seed coating composition. In preferred embodiments, the aqueous seed coating compositions described herein comprise from about 1 wt. % to about 50 wt. % of the binder, based on the weight of the seed coating composition, or from about 1 wt. % to about 40 wt. %, or from about 1 wt. % to about 30 wt. %. In other embodiments, the seed coating compositions described herein comprise from about 3 wt. % up to about 15 wt. % of the binder, based on the weight of the seed coating composition. In still other embodiments, the seed coating compositions described herein comprise from about 4 wt. % up to about 10 wt. % of the binder, based on the weight of the seed coating composition. In still yet other embodiments, the seed coating compositions described herein comprise from about 6 wt. % up to about 8 wt. % of the binder, based on the weight of the seed coating composition.

In some embodiments, the aqueous seed coating compositions described herein comprise from of about 1 wt. % to about 99 wt. % of one or more modified starch as the binder, based on the weight of the seed coating composition, or from about 1 wt. % to about 90 wt. %, 1 wt. % to about 80 wt. %, 1 wt. % to about 70 wt. %, 1 wt. % to about 60 wt. %, 1 wt. % to about 50 wt. %, 1 wt. % to about 40 wt. %, 1 wt. % to about 30 wt. %, 1 wt. % to about 20 wt. %, or 1 wt. % to about 10 wt. % of one or more modified starch as the binder, based on the weight of the seed coating composition. In preferred embodiments, the aqueous seed coating compositions described herein comprise from about 1 wt. % to about 40 wt. % of one or more modified starch as the binder, based on the weight of the seed coating composition, or from about 1 wt. % to about 30 wt. %. In other embodiments, the seed coating compositions described herein comprise from about 3 wt. % up to about 15 wt. % of one or more modified starch as the binder, based on the weight of the seed coating composition. In still other embodiments, the seed coating compositions described herein comprise from about 4 wt. % up to about 10 wt. % of one or more modified starch as the binder, based on the weight of the seed coating composition. In still yet other embodiments, the seed coating compositions described herein comprise from about 6 wt. % up to about 8 wt. % of one or more modified starch as the binder, based on the weight of the seed coating composition.

In some embodiments, the aqueous seed coating compositions described herein comprise from of about 1 wt. % up to about 99 wt. % of un-modified starch, based on the weight of the binder, or from about 1 wt. % up to about 90 wt. %, 1 wt. % up to about 80 wt. %, 1 wt. % up to about 70 wt. %, 1 wt. % up to about 60 wt. %, 1 wt. % up to about 50 wt. %, 1 wt. % up to about 40 wt. %, 1 wt. % up to about 30 wt. %, 1 wt. % up to about 20 wt. %, or 1 wt. % up to about 10 wt. % of un-modified starch, based on the weight of the binder. In preferred embodiments, the aqueous seed coating compositions described herein comprise from about 1 wt. % up to about 40 wt. % of un-modified starch, or from about 1 wt. % up to about 30 wt. %, based on the weight of the binder. In some embodiments, the seed coating compositions described herein comprise up to about 90%, up to about 80%, up to about 70%, up to about 60%, up to about 50%, up to about 40%, up to about 30%, up to about 20%, or up to about 10% of un-modified starch, based on the weight of the binder.

In some embodiments, the aqueous seed coating compositions described herein comprise from of about 1 wt. % up to about 99 wt. % of synthetic polymer, based on the weight of the binder, or about 1 wt. % up to about 95 wt. %, about 1 wt. % up to about 90 wt. %, about 1 wt. % up to about 80 wt. % about 1 wt. % up to about 70 wt. % about 1 wt. % up to about 60 wt. %, about 1 wt. % up to about 50 wt. % about 1 wt. % up to about 40 wt. % about 1 wt. % up to about 30 wt. %, about 1 wt. % up to about 99 wt. % about 1 wt. % up to about 20 wt. % about 1 wt. % up to about 10 wt. %. In some embodiments, the aqueous seed coating compositions described herein comprise up to 95 wt. % synthetic polymer, based on the weight of the binder.

In some embodiments, the aqueous seed coating compositions described herein comprise from of about 1 wt. % up to about 99 wt. % of enzymatically converted starch, based on the weight of the binder, or about 1 wt. % up to about 95 wt. %, about 1 wt. % up to about 90 wt. %, about 1 wt. % up to about 80 wt. % about 1 wt. % up to about 70 wt. % about 1 wt. % up to about 60 wt. %, about 1 wt. % up to about 50 wt. % about 1 wt. % up to about 40 wt. % about 1 wt. % up to about 30 wt. %, about 1 wt. % up to about 99 wt. % about 1 wt. % up to about 20 wt. % about 1 wt. % up to about 10 wt. %. In some embodiments, the aqueous seed coating compositions described herein comprise up to 99 wt. % enzymatically converted starch, based on the weight of the binder.

In some embodiments, the aqueous seed coating compositions described herein are applied to a seed at a rate of about 294.0-887.4 g/45.36 kg seed, about 443.7 g/45.36 kg seed, about 473.3 g/45.36 kg seed, about 502.8 g/45.36 kg seed, about 532.4 g/45.36 kg seed, about 562.0 g/45.36 kg seed, about 591.6 g/45.36 kg seed, or about 621.2 g/45.36 kg seed, about 650.8/45.36 kg seed, about 680.3 g/45.36 kg seed, about 708.0 g/45.36 kg seed, about 739.5 g/45.36 kg seed, about 769.1 g/46.36 kg seed, about 798.7 g/46.36 kg seed, about 828.0 g/45.36 kg seed, about 857.8 g/45.36 kg seed and about 887.4 g/45.36 kg seed. In some embodiments, the aqueous seed coating compositions described herein are applied to a seed at a rate of about 2.84-284 g/45.36 kg seed, about 5.68 g/45.36 kg seed, about 14.2-284 g/45.36 kg seed, about 28.4-99.4 g/45.36 kg seed, about 42.6-95.2 g/45.36 kg seed, about 56.8-85.2 g/45.36 kg seed, about 56.8-71 g/45.36 kg seed, or about 5.68 g/45.36 kg seed, about 14.2 g/45.36 kg seed, about 21.3 g/45.36 kg seed, about 28.4 g/45.36 kg seed, about 42.6 g/45.36 kg seed, about 56.8 g/46.36 kg seed, about 71 g/46.36 kg seed, about 85.2 g/45.36 kg seed, about 99.4 g/45.36 kg seed, about 113 g/45.36 kg seed, about 127.8 g/45.36 kg seed, about 142 g/45.36 kg seed, about 170.4 g/45.36 kg seed, about 198.8 g/45.36 kg seed, about 227.2 g/45.36 kg seed, about 255.6/46.36 kg seed or about 284 g/45.36 kg seed or about 5.68 g/45.36 kg seed or more, about 14.2 g/45.36 kg seed or more, about 21.3 g/45.36 kg seed or more, about 28.4 g/45.36 kg seed or more, about 42.6 g/45.36 kg seed or more, about 56.8 g/46.36 kg seed or more, about 71 g/46.36 kg seed or more, about 85.2 g/45.36 kg seed or more, about 99.4 g/45.36 kg seed or more, about 113 g/45.36 kg seed or more, about 127.8 g/45.36 kg seed or more, or about 142 g/45.36 kg seed or more, or about 284 g/45.36 kg seed or more.

In some embodiments, the aqueous seed coating compositions described herein are free of un-modified starch. In other embodiments, the aqueous seed coating compositions described herein comprise (i) a binder comprising a modified starch, a synthetic polymer, an enzymatically converted starch (which includes, for example, maltodextrin, polysaccharide mixtures, or combinations thereof), an unmodified starch, or a combination thereof; and (ii) an active ingredient. In yet other embodiments, the aqueous seed coating compositions described herein comprise (i) a binder comprising a modified starch, a synthetic polymer, an enzymatically converted starch (which includes, for example, maltodextrin, polysaccharide mixtures, or combinations thereof), or a combination thereof; and (ii) an active ingredient. In still other embodiments, the binder contained in the aqueous seed coating compositions described herein comprise up to 95 wt. % synthetic polymer, based on weight of the binder. In yet still further embodiments, the binder contained in the aqueous seed coating compositions described herein comprise up to 99 wt. % enzymatically converted starch, based on weight of the binder. In even still further embodiments, the binder contained in the aqueous seed coating compositions described herein comprise up to 40 wt. % un-modified starch, based on weight of the binder. In some embodiments, the one or more binders used to make the aqueous seed coating compositions described herein may be in a liquid or powder form.

In some embodiments, the aqueous seed coating compositions described herein are free of polymer binding agents, such as, e.g., synthetic polymer binders.

Polymer binders that are used in seed coating compositions are well-known in the art and include, but are not limited to, for example, water-soluble polymers, such as, e.g., polyvinyl acetate, polyvinyl alcohol, polyvinyl pyrrolidone, polyurethane, methyl cellulose, carboxymethyl cellulose, hydroxylpropyl cellulose, sodium alginate, polyurethane, polyacrylate, casein, gelatin, pullulan, polyacrylamide, polyethylene oxide, and poly(N-vinylacetamide).

Waxes, such as, e.g., carnauba wax, paraffin wax, polyethylene wax, bees wax, and polypropylene wax can be used as a binder or as an extra flow additive. Also, ethylene vinyl acetate can suitably be used as a binder.

### Dispersing Additive

In another embodiment, the aqueous seed coating compositions described herein further comprises a wetting and dispersing additive (sometimes also referred to as pigment dispersant). Suitable wetting and dispersing additives include, but are not limited to, e.g., ionic and non-ionic products and include solutions of organo-modified polyacrylates, polyacrylates, sodium polyacrylate, polyurethane, phosphoric acid ester, star polymers, modified polyethers, and combinations thereof. In one embodiment, the aqueous seed coating compositions described herein comprise from about 1 to 20 wt. % or more wetting and dispersing additive, based on the total weight of the seed coating composition.

### Plasticizers

In any embodiment, the one or more aqueous seed coating compositions comprises a plasticizer such as glycerol, propylene glycol, polyethylene glycol, sorbitol, low DE (dextrose equivalent) corn syrup, or other plasticizers used in the art of seed coating, and combinations thereof. In further embodiments, the aqueous seed coating compositions described herein comprise from about 1 wt. % to about 20 wt. % plasticizer, or from about 1 wt. % to about 10 wt. % plasticizer, or from about 1 wt. % to about 5 wt. % plasticizer, or from about 5 wt. % to about 20 wt. % plasticizer, or from about 5 wt. % to about 10 wt. % plasticizer, based on the total weight of the binder comprising the modified starch.

### Solvent

In another embodiment, the aqueous seed coating compositions described herein comprise from about 1 wt. % to about 5 wt. % solvent, based on the total weight of the seed coating composition. Suitable solvents include, but are not limited to, e.g., alcohol, butyl glycol, ethylene glycol, polyethylene glycol, glycerol, texanol ((3-hydroxy-2,2,4-trimethyl-pentyl) 2-methylpropanoate), and combinations thereof.

### Thickeners

In another embodiment, the aqueous seed coating compositions described herein comprise from about 0.05 wt. % to about 2 wt. % thickener, based on the total weight of the seed coating composition. Suitable thickeners include, but are not limited to, agar, carboxy methylcellulose, carrageen, chitin, fucoidan, ghatti, gum arabic, karaya, laminaran, locust bean gum, pectin, alginate, guar gum, xanthane gum, tragacanth gum, bentonite clays, HEUR (hydrophobically modified, ethoxylated urethane) thickeners, HASE (hydrophobically modified, alkali-swellable emulsion) thickeners, polyacrylates, and combinations thereof. In some embodiments, the thickener is a gum.

### Coloring Agents

In some embodiments, the aqueous seed coating compositions described herein comprise from about 1 wt. % to about 50 wt. % of a coloring agent, based on the total weight of the seed coating composition. Suitable coloring agents include, but are not limited to, e.g. dyes or pigmented colorants. Suitable dyes include, but are not limited to, e.g., anthraquinone, triphenylmethane, phthalocyanine and derivatives thereof, diazonium salts, and combinations thereof. Colorants can contain pigments, such as, e.g., pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793-37-8), pigment white 6 (CAS No. 98084-96-9), and combinations thereof.

### Anti Foaming Agents

In further embodiments, the aqueous seed coating compositions described herein comprise from about 0.05 wt. % to about 0.3 wt. % anti-foaming agent, based on the total weight of the seed coating composition. Suitable anti-foaming agents include, but are not limited to, e.g., polyethylene glycol, glycerin, mineral oil defoamers, silicone defoamers, and non-silicone defoamers (such as polyethers, polyacrylates), dimethylpolysiloxanes (silicone oils), arylalkyd modified polysiloxanes, polyether siloxane copolymer containing fumed silica, and combinations thereof.

### Effect Pigments

In yet further embodiments, the aqueous seed coating compositions described herein comprise effect pigments. Suitable effect pigments include, but are not limited to, e.g., pearlescent pigment, aluminum, or combinations thereof. In some embodiments, the effect pigment has a particle size of 15 μm or less or a particle size of 60 μm or less. In other embodiments, the particle size of the effect pigment is not more than 200 μm or not more than 100 μm. In still other embodiments, the particle size of the effect pigment is 1 μm or more. All effect pigments are commonly used to create a nice cosmetic look on the seeds.

In yet further embodiments, titanium dioxide is used as an effect pigment to improve the luster of coated seeds. In some embodiments, the aqueous seed coating compositions described herein comprise effect titanium dioxide. In some embodiments, the aqueous seed coating compositions described herein comprise from about 1 wt. % to about 10 wt. % titanium dioxide, based on the total weight of the seed coating composition, or from about 1 wt. % to about 5 wt. %, or preferably from about wt. %, 5 wt. % to about 10 wt. %, based on the total weight of the seed coating composition.

### Emulsifiers

In yet further embodiments, the aqueous seed coating compositions described herein comprise emulsifiers. Emulsifiers suitable for use in the aqueous seed coating composition include, for example, the polysorbate family, which includes Tween 80, diglycol laurate, glyceryl oleate, 2-amino-2-methylol-1, 3-propanediol stearate, stearyl glutamic acid, and triethanolamine stearate. Other emulsifiers are also typically used in the art of preparing agricultural formulations and compositions.

In some embodiments, the aqueous seed coating compositions described herein comprise an emulsifier in the range of from about 1 wt. % to about 10 wt. % emulsifier, based on the total weight of the seed coating composition, or from about 1 wt. % to about 5 wt. %, or preferably from about wt. %, 5 wt. % to about 10 wt. %, based on the total weight of the seed coating composition.

### Biocide

In still yet further embodiments, the aqueous seed coating compositions described herein comprise a biocide. The biocide is typically included in an aqueous seed coating composition to prolong the shelf life of the seed coating composition before being applied to a seed, such as, e.g., when being stored.

### Active Ingredients

In one embodiment, the one or more active ingredients contained in the aqueous seed coating compositions described herein are selected from a pesticide, a plant growth regulator, a crop desiccant, a fungicide, a bactericide, a bacteriostat, an insecticide, a nematicide, an insect repellant, a triazine, a sulfonylurea, a uracil, a urea, an acetanilide, an organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, a acylamine fungicide, a chlorinated aromatic, a dichloro aniline fungicide, a carbamate insecticide, an organo thiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, and a fertilizer. In addition, the one or more active ingredient can be any bio-pesticide from a plant or microbial origin and/or biological live beneficial microbes from bacterial, fungal genera, and any combinations thereof. In another embodiment, the one or more active ingredients contained in the aqueous seed coating compositions described herein are selected from a pesticide, a plant growth regulator, a crop desiccant, a fungicide, a bio-pesticide, a biologic containing bacterial or fungal genera, a bactericide, a bacteriostat, an insecticide, a nematicide, an insect repellant, or any combination thereof.

In some embodiments, the one or more active ingredient can further comprise an adjuvant, a surfactant, a fertilizer, or any combination thereof.

### Coated Seeds

Some embodiments are directed to one or more seed coated with one or more aqueous seed coating compositions described herein. In other embodiments, the one or more seeds are agricultural seeds, vegetable seeds, herb seeds, wildflower seeds, ornamental seeds, grass seeds, tree seeds, bush seeds, or any combination thereof.

In further embodiments, the plant seed is an agricultural seed. The seed may be of the order of Monocotyledoneae or of the order of Dicotyledoneae. Suitable seeds include, but are not limited to, e.g., seed of soybean, cotton, corn, peanut, maize, wheat, barley, oat, rye triticale, mustard, sunflower, sugar beet, safflower, millet, chicory, flax, rapeseed, buckwheat, tobacco, cannabis, hemp, alfalfa, signal grass, clover, sorghum, chick pea, beans, peas, vetch, rice, sugar cane, linseed, and combinations thereof. Examples of suitable vegetable seeds include, but are not limited to, asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, watermelon, melon, cucumber, gherkin, marrow, parsley, fennel, pea, bean, radish, black salsify, eggplant, corn, carrot, onion, tomato, pepper, lettuce, cucurbit, shallot, broccoli, brassica, Brussel sprouts, and combinations thereof.

Preferably, the plant seed is capable of germinating. Optionally, the seed may be deprived of husk (so-called husked seed or de-hulled seed). The seed may be primed or not primed (having been subjected to a treatment to improve the germination rate, e.g. osmopriming, hydropriming, matrix priming).

### Coating Methods

In some embodiments, the aqueous seed coating compositions described herein are applied to a seed in a single application step. In another embodiment, the aqueous seed coating composition described herein are applied in multiple application steps.

Some embodiments are directed to a method for coating a seed, comprising: (i) admixing a binder comprising a modified starch with an active ingredient to form a seed coating composition; and (ii) applying said composition to one or more seed.

Seeds may be coated with one or more aqueous seed coating compositions described herein by applying the compositions directly to the seed. In some embodiments, the seeds may be over treated with one or more active ingredients. In another embodiment, the seed may be treated indirectly, for example, by treating the environment or habitat to which the seed is exposed. Conventional treatment methods may be used to treat the environment or habitat including dipping, spraying, fumigating, chemigating, fogging, scattering, brushing on, shanking or injecting.

In some embodiments, the active ingredients, colorant and binder comprising modified starch can be added separately to the seed coating equipment using an atomizer or a spinning disc devise to apply a uniform coating of the composition to the one or more seed.

Subject matter contemplated by the present disclosure is set out in the following numbered embodiments:
1. An aqueous seed coating composition comprising: a binder comprising a modified starch, and an active ingredient; and optionally, wherein the modified starch comprises amylose, amylopectin, or any combination thereof
2. The composition of claim 1, wherein the modified starch is selected from a cereal, a tuber, a root, a legume, fruit, or any combination thereof; and
optionally, wherein the modified starch is selected from corn, pea, potato, sweet potato, banana, barley, wheat, rice, sago, amaranth, tapioca, arrowroot, canna, or sorghum, waxy or high amylose varieties thereof, or any combination thereof.
3. The composition of any preceding claim, wherein the modified starch is etherified, oxidized, methylated, ethylated, propylated, alkoxylated, carboxymethylated, cationic, esterified, acylated, succinated, propylated and phosphate cross-linked, dextrinized, or any combination thereof;
   optionally, wherein the modified starch has been hydrolyzed by acid, enzyme, oxidant, and/or physically to reduce molecular weight;
   optionally, wherein the modified starch is acid hydrolyzed-2-hydroxypropyl ether, dextrinized hydrogen octenyl butanedioate, acetate hexadioate, 2-hydroxyl; and optionally, wherein the modified starch is waxy, 100% amylopectin, naturally anionic phosphate, pregelatinized, or any combination thereof.
4. The composition of any preceding claim, wherein the active ingredient is
   (i) a pesticide, a plant growth regulator, a crop desiccant, a fungicide, a bio-pesticide, a biologic containing bacterial or fungal genera, a bactericide, a bacteriostat, an insecticide, a nematicide, an insect repellant, or any combination thereof; or
(ii) a pesticide, a plant growth regulator, a crop desiccant, a fungicide, a bactericide, a bacteriostat, an insecticide, an insect repellant, a triazine, a sulfonylurea, a uracil, a urea, and organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, an acylamine fungicide, a chlorinated aromatic, a dichloro aniline fungicide, a carbamate insecticide, an organothiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, a fertilizer, a bio-pesticide from plant or microbial origin or biological live beneficial microbe from bacterial or fungal genera, or any combination thereof
5. The composition of any preceding claim, further comprising a second binder, a filler, a nutrient, a wetting and dispersing additive or a pigment dispersant, a solvent, a plasticizer, an emulsifier, a thickener, a coloring agent or pigment, an anti-foaming agent, a biocide, a surfactant, mica, titanium dioxide, or any combination thereof; and
   optionally, wherein the binder further comprises a synthetic polymer, an
   enzymatically converted starch, or a combination thereof.
6. The composition of any preceding claim, wherein the binder comprises up to 95 wt. % synthetic polymer, based on the weight of the binder;
   optionally, wherein the composition comprises up to 99 wt. % enzymatically converted starch, based on the weight of the binder; and
   optionally, wherein the composition is free of unmodified starch.
7. The composition of any preceding claim, wherein the binder further comprises up to 40 wt. % un-modified starch, based on the weight of the binder.
8. Use of the composition of any preceding claim to coat a seed.
9. A coated seed comprising the composition of any preceding claim.
10. A coated seed comprising the composition of any preceding claim;
wherein the seed is an agricultural seed, a vegetable seed, an herb seed, a wildflower seed, an ornamental seed, a grass seed, a tree seed, a bush seed, or any combination thereof;
optionally, wherein the seed is selected from a soybean, cotton, corn, peanut, maize, wheat, barley, oat, rye triticale, mustard, sunflower, sugar beet, safflower, millet, chicory, flax, rapeseed, buckwheat, tobacco, cannabis, hemp, alfalfa, signal grass, clover, sorghum, chick pea, bean, pea, vetch, rice, sugar cane, linseed, and any combination thereof; and optionally, wherein the vegetable seed is selected from asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, water melon, melon, cucumber, marrow, parsley, fennel, pea, bean, radish, black salsify, eggplant, corn, carrot, onion, tomato, pepper, lettuce, cucurbit, shallot, broccoli, brassica, brussel sprout, and any combination thereof
11. A method for coating one or more seed, comprising:
   (i) admixing a binder comprising a modified starch with an active ingredient to form an aqueous seed coating composition; and
   (ii) applying the composition to one or more seed; and
   optionally, wherein the modified starch comprises amylose, amylopectin, or any combination thereof
12. The method of claim 11,
   wherein the modified starch is from a cereal, a tuber, root, legume, fruit, or any combination thereof; and
   optionally, wherein the modified starch is from corn, pea, potato, sweet potato, banana, barley, wheat, rice, sago, amaranth, tapioca, arrowroot, canna, sorghum, waxy or high amylose varieties thereof, or any combination thereof
13. The method of any one of claims 11-12, wherein the modified starch has been modified through one or more of oxidation, phosphate addition, crosslinking, esterification, etherification, dextrinization, or any combination thereof; and
optionally, wherein the modified starch has been hydrolyzed by acid, enzyme, and/or oxidant to reduce molecular weight;
optionally, wherein the modified starch is waxy, 100% amylopectin, naturally anionic phosphate, pregelatinized (warm or cold water dispersible), or any combination thereof; and
optionally, wherein the modified starch is acid hydrolyzed-2-hydroxypropyl ether, dextrinized hydrogen octenyl butanedioate, acetate hexadioate, 2-hydroxyl-3-(trimethylammonio)propyl ether chloride, canary dextrin, or any combination thereof.
14. The method claim 11, wherein the seed coating composition further comprises one or more active ingredient, wherein the active ingredient is
   (i) a pesticide, a plant growth regulator, a crop desiccant, a fungicide, a bio-pesticide, a biologic containing bacterial or fungal genera, a bactericide, a bacteriostat, an insecticide, a nematicide, an insect repellant, or any combination thereof; or
   (ii) a pesticide, a plant growth regulator, a crop desiccant, a fungicide, a bactericide, a bacteriostat, an insecticide, an insect repellant, a triazine, a sulfonylurea, a uracil, a urea, and organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, an acylamine fungicide, a chlorinated aromatic, a dichloro aniline fungicide, a carbamate insecticide, an organothiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, a fertilizer, a bio-pesticide from plant or microbial origin or biological live beneficial microbe from bacterial or fungal genera, or any combination thereof;
   optionally, wherein the seed coating composition further comprises a binder, a filler, a nutrient, a wetting and dispersing additive or a pigment dispersant, a solvent, a thickener, a coloring agent or a pigment, an anti-foaming agent, a biocide, a surfactant, mica, titanium dioxide, or any combination thereof; and
   optionally, wherein the binder further comprises a synthetic polymer, an enzymatically converted starch, or a combination thereof
15. The composition of claim 14, wherein the binder comprises up to 95 wt. % synthetic polymer, based on the weight of the binder;
   optionally, wherein the composition comprises up to 99 wt. % enzymatically converted starch, based on the weight of the binder;
   optionally, wherein the composition is free of unmodified starch; and
   optionally, wherein the binder further comprises up to 40 wt. % un-modified starch, based on the weight of the binder.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1: Corn Seed Coating

Equipment: A clear plastic bag or a Continuous Batch Treating System (Gustafson CBT-200, Bayer Crop Science) was used to apply the exemplary seed coating compositions to the seeds.

For the flowability tests, a metal galvanized funnel was used. For the dust-off tests, a Heubach Dustmeter (Heubach, Salzburg, Germany) was used for plantability, John Deere vacuum planter was used.

Materials & Chemistry: A commercially available active ingredient blend commonly used in seed coating compositions is set forth in Table 1 (hereinafter “Active Ingredient Blend I”). The Active Blend I described in Table 1 is used in the seed coating compositions described in Examples 1 and 2.

TABLE 1
Active Ingredient Blend I

| Active Ingredients | Function | Grams/45.36 kg Seed |
|---|---|---|
| Acceleron ® D-281 fungicide | Fungicide | 3.0 |
| (fluoxastrobin, 41.4%) | | |
| (Bayer, St. Louis, MO) | | |
| Acceleron ® DX-342 fungicide | Fungicide | 7.1 |
| (Prothioconazole, 41%) | | |
| (Bayer, St. Louis, MO) | | |
| Acceleron ® DX-309 fungicide | Fungicide | 7.1 |
| (Metalaxyl, 28.35%) | | |
| (Bayer, St. Louis, MO) | | |
| Poncho ® Votivo ® seed | Insecticide & | 33.4 |
| treatment (Clothianidin, | Nematicide | |
| 40.3% and Bacillus Firmus | | |
| (1-582), 8.1%) (BASF, | | |
| Research Triangle Park, NC) | | |

Seeds used to prepare Table 2 coated seeds: XL-Corn Seed (Round variety) (Beck's Hybrids, Atlanta, Ind.).

Seeds used to prepare Table 3 coated seeds: Corn seeds, Variety S-2338 (Ingredion Inc., Westchester, Ill.).

Colorant: Chromatint® Red 40 (Chromatech, Inc., Canton, Mich.).

Mica: Pyrisma® F80-51 SW Ferric red (Merck KGaA, Darmstadt, Germany).

Coating materials: Commercially available Precise 1006 synthetic polymer binder (saxagliptin hydrochloride/dapagliflozin propanediol polymer) (Bayer Crop Science, Research Triangle Park, N.C.). Commercially available starches: liquid cationic starch, Amylopectin, 2-hydroxy-3-(trimethlylammonio) propyl ether chloride; liquid modified starch, dextrinized hydrogen octenylbutanediote (an octenyl succinate (OSA) modified starch); liquid modified starch, Amylopectin, Acid hydrolyzed, 2-hydroxypropyl ether (hydroxy propyl (PO) modified starch); and waxy amylopectin (unmodified starch); Corn starch (un-modified starch) (Ingredion Inc., Westchester, Ill.). Starch and modified starches above were present in the seed coating compositions in the range of 1-50 weight percent of the coating material, or between 30-40 weight percent of the coating material.

Method for Preparing Table 2 Coated Seeds: The Active Ingredient Blend I shown in Table 1 was prepared. Seed coating composition was subsequently prepared by combining 50.6 g/45.36 kg seed of the Active Ingredient Blend I with 7.9 g/45.36 kg seed of the Chromatint® Red 40, 383.5 g/45.36 kg seed of water, and 148 g/45.36 kg seed of a coating material set forth hereinabove. The XL-Corn Seeds were coated with a seed coating composition by adding the seeds and the seed coating composition to a clear plastic bag, which was blown using air and shaken for 50 seconds. After 50 seconds, 1.0 g of dry Mica powder was added to the bag and then shaken for an additional 10 seconds to provide uniformly coated, dry seeds.

The seeds were treated in 0.45 kg batches, with five batches of seeds being coated. The five 0.45 kg seed batches were combined, with a Sample number. being assigned to the composite 2.25 kg batch. For each 0.45 kg bag of seeds, 5.9 g of the seed coating composition described as above was used for coating the seeds. The seed coating composition for each composite batch is set forth in Table 2.

TABLE 2

| Sample | Seed Coating Compositions | Batch size |
|---|---|---|
| 1 | Not Coated | N/A |
| 2 | Active Ingredient Blend I, Chromatint ® Red 40, | 2.25 kg |
| | water, and Precise 1006 synthetic polymer | |
| 3 | Active Ingredient Blend I, Chromatint ® Red 40, | 2.25 kg |
| | water, and OSA modified starch | |
| 4 | Active Ingredient Blend I, Chromatint ® Red 40, | 2.25 kg |
| | water, and PO modified starch | |
| 5 | Active Ingredient Blend I, Chromatint ® Red 40, | 2.25 kg |
| | water, and un-modified waxy amylopectin | |
| 6 | Active Ingredient Blend I, Chromatint ® Red 40, | 2.25 kg |
| | water, and un-modified corn starch | |

Method for Preparing Table 3 Coated Seeds: The Active Ingredient Blend I shown in Table 1 was prepared. Each seed coating composition was subsequently prepared by combining 50.6 g/45.36 kg seed of the Active Ingredient Blend I with 7.9 g/45.36 kg seed, Chromatint® Red 40, 383.5 g/45.36 kg seed of water, and 148 g/45.36 kg seed of each coating material set forth hereinabove. The S-2338 corn seeds were subsequently coated with a seed coating composition set forth in Table 3 via a Continuous Batch Treating System. For each batch of 135 kg seeds, 1756 g of seed coating composition was used for coating the seeds.

TABLE 3

| Sample | Seed Coating Compositions | Batch size |
|---|---|---|
| 7 | Not coated | N/A |
| 8 | Active Ingredient Blend I, Chromatint ® Red 40, | 135 kg |
| | water, and Precise 1006 synthetic polymer | |
| 9 | Active Ingredient Blend I, Chromatint ® Red 40, | 135 kg |
| | water, and modified cationic starch | |
| 10 | Active Ingredient Blend I, Chromatint ® Red 40, | 135 kg |
| | water, and OSAmodified starch | |
| 11 | Active Ingredient Blend I, Chromatint ® Red 40, | 135 kg |
| | water, and PO modified starch | |
| 12 | Active Ingredient Blend I, Chromatint ® Red 40, | 135 kg |
| | water, and un-modified corn starch | |

To assess the efficiency of the delivery of coating compositions, the coated seed samples prepared in Table 3 were analyzed for the presence of the active ingredients (insecticides & fungicides in the Active Ingredient Blend I). The results are shown in Table 4.

TABLE 4
Active Ingredient levels and % of Active Ingredients Recovered On The Coated Seeds

| | | | | | Total | Total | % |
|---|---|---|---|---|---|---|---|
| | Clothianidin | Metalaxyl | Fluoxastrobin | Prothioconazole | Actives | Actives | Recovery |
| | (Insecticide. | (Fungicide, | (Fungicide, | (Fungicide, | Recovered | Theoretical | Active |
| Sample | μg/seed) | μg/seed) | μg/seed) | μg/seed) | (μg/seed) | (μg/seed) | Ingredients |
| 8 | 422 | 13 | 15 | 4 | 454 | 500 | 91 |
| 9 | 465 | 14 | 19 | 8 | 506 | 500 | 101 |
| 10 | 472 | 13 | 20 | 8 | 513 | 500 | 103 |
| 11 | 428 | 13 | 19 | 8 | 468 | 500 | 94 |
| 12 | 447 | 14 | 20 | 8 | 489 | 500 | 98 |

The data demonstrated that seeds coated with a commercial synthetic binder and the seeds coated with both modified and unmodified starch provided uniform coverage of the treated seeds with active ingredient, while efficiently delivering the active ingredients to the surface of the seeds (See Table 4). The percent recovery of total active ingredients (91-103%) on the coated seeds demonstrate that modified and un-modified starch coatings on seed samples (samples 9-12) provided uniform coverage and efficient delivery of the active ingredients blend, at least as well as or better than a coating containing a commercial synthetic polymer binder (sample 8). The seed coating containing modified starch (samples 9-11) contained comparable or higher amounts of total active ingredients when compared to the seed coating containing the unmodified starch (sample 12). Surprisingly, some of the seed coatings containing modified starch (e.g., samples 9 and 10) provided complete recovery of the applied active ingredients blend.

Regarding the recovery of individual active ingredient components of the Active Ingredient Blend I, seed coatings containing either modified or unmodified starches (samples 9-12) yielded equivalent or higher amounts of individual active ingredients than did seed coatings containing the commercial synthetic polymer binder (sample 8). Surprisingly, most of the modified starches provided greater amounts of at least one active ingredient (e.g., clothianidin).

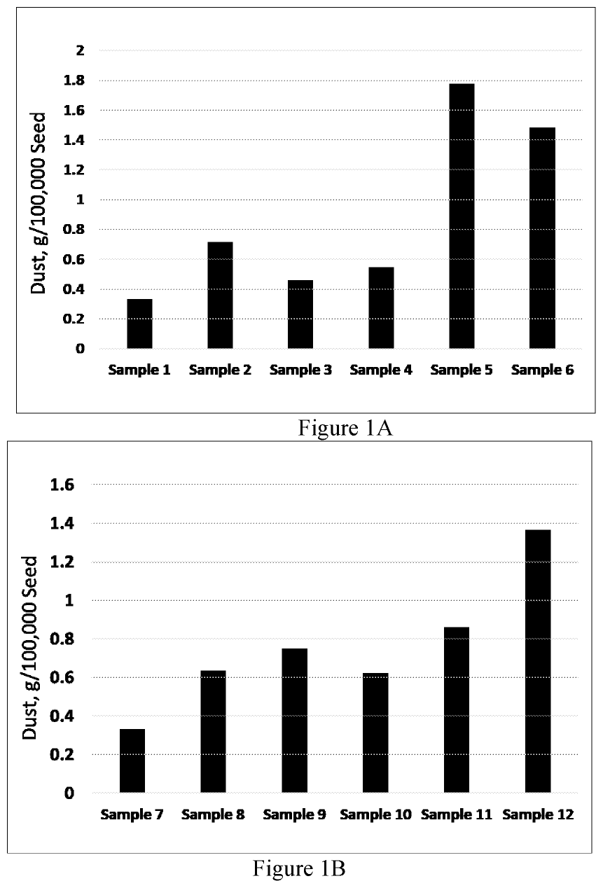

Even though unmodified starch provided excellent coverage and percent recovery of total active ingredients, the data generated indicates that seeds coated with a seed coating composition containing unmodified starch provided poor dust-off and flowability properties. Dust-off analysis. Dust off measurements were performed to determine the amounts of dust shed by the coated seeds when subjected to handling. A Heubach Dustmeter was used to analyze the seed coating dust-off for each batch of coated seeds prepared in Example 1. For each batch of seeds, a 100-g coated seed sample was added to the drum of the Heubach Dustmeter. 20 liters/minute of dry air was passed through the drum while rotating at 30 RPM for 2 minutes. The dust was collected on a filter paper and weighed; the dust off measurement was quantified by weight difference. A seed count was performed to determine the mean grams of dust per 100,000 seeds. Two replicates were run for each sample and results were averaged for plotting. The results are shown in FIGS. 1A-1B. It is desired to have the pools of coated seeds generate the lowest amount of dust possible.

As shown in FIGS. 1A-1B, which show the results for two species of corn seeds, uncoated corn seeds (samples 1 and 7) generated the lowest amounts of dust. Corn seeds coated with seed coating compositions containing synthetic polymers (samples 2 and 8) generated greater amounts of dust than uncoated corn seeds (samples 1 and 7), while seed coating compositions containing an unmodified starch (samples 5-6 and 12) generated the greatest amounts of dust.

Corn seeds coated with a seed coating composition containing a modified starch (samples 3, 4, and 9-11) generated lower dust-off amounts compared to corn seeds coated with a seed coating composition containing an unmodified starch (samples 5-6 and 12). Corn seeds coated with seed compositions containing modified starch (OSA modified starch (samples 3 and 10), PO modified starch (samples 4 and 11), and cationic starch (sample 9) surprisingly generated comparable or lower amounts of dust than corn seeds coated with seed compositions containing synthetic polymers (samples 2 and 8).

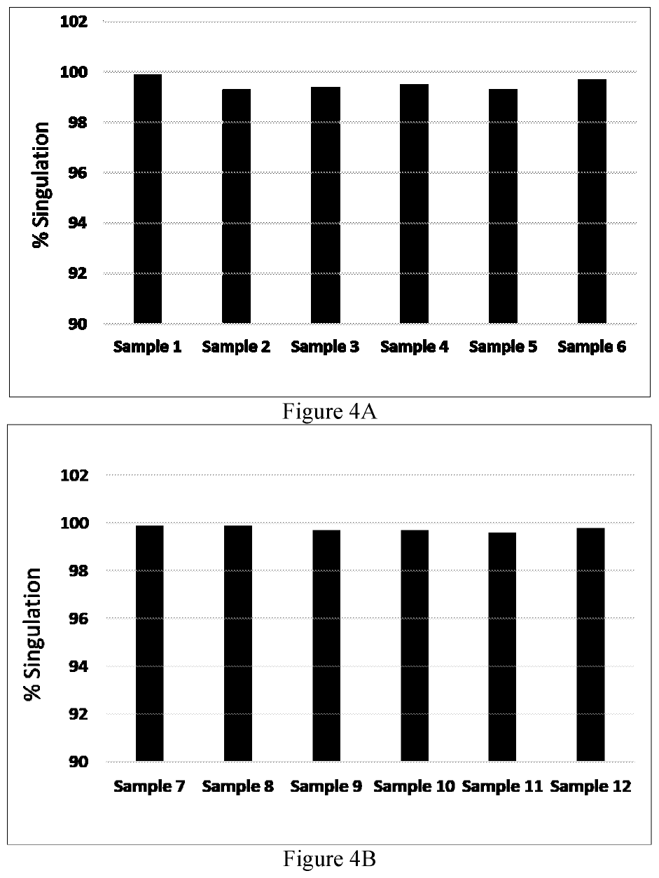

Plantability Testing. Plantability equipment provides a simulation of a planter device that determines the number of times that a single seed is successfully picked up and fed to the seed tube, versus delivering multiple seeds or delivering no seeds to the seed tube. Plantability equipment measures % singulation, skips and misses. Seeds were pre-conditioned at 25±0.6° C. and 74-75% relative humidity and the same temperature and humidity was used for planting meter testing. Precision Planting meter eSet using John Deere vacuum planting head was used. The planting meter was be set to a setting with a seeds/acre count of 35,000, a speed of 4.1 mph, and a vacuum rate of 18.1 psi. The vacuum planting unit simulates planting in the field and uses air pressure to attach the seeds to the disk. The machine records information such as skips, multiple seed deposits and loss/acre. Approximately 1000 grams of seed was used for each test (amount that fills the hopper). Plantability results for coated corn seeds are shown in FIGS. 4A-4B. It is desired to have the highest % singulation, or delivery of single seeds, possible. Seeds coated with a seed coating composition containing starch binders showed comparable or slightly better % singulation compare to seeds coated a seed coating composition containing synthetic polymer binder.

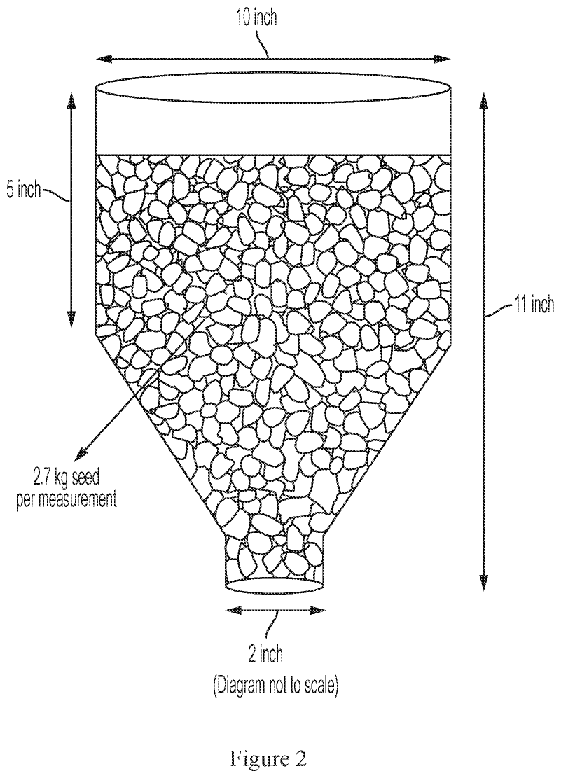

Flowability Testing. Flowability relates to the ability of individual seeds in a seed population to flow or slide past each other as particles. Flowability of the coated corn seeds was measured using a metal funnel. 10 replicates of each sample were measured. 2.7 kg of each sample was passed through the funnel and the amount of time that elapsed before all of the seeds had passed through the funnel was recorded. A schematic diagram of the flowability funnel is shown in FIG. 2. 56.8 g/45.36 kg seed rate of talc powder was added to each sample for flowability measurements. Seeds were treated in 4.5 kg batches to perform the flowability tests and the results are shown in Table 5. The lower the elapsed time, the better the flowability.

TABLE 5
Flowability of Coated Corn Seeds

| Sample 8 | | Sample 9 | | Sample 10 | | Sample 11 | | Sample 12 | |
|---|---|---|---|---|---|---|---|---|---|
| | Elapsed | | Elapsed | | Elapsed | | Elapsed | | Elapsed |
| | Time | | Time | | Time | | Time | | Time |
| Replicates | (Secs) | Replicates | (Secs) | Replicates | (Secs) | Replicates | (Secs) | Replicates | (Secs) |
| 1 | 7.51 | 1 | 7.83 | 1 | 7.61 | 1 | 7.61 | 1 | 7.86 |
| 2 | 7.46 | 2 | 7.63 | 2 | 7.58 | 2 | 7.43 | 2 | 7.72 |
| 3 | 7.43 | 3 | 7.68 | 3 | 7.48 | 3 | 7.51 | 3 | 7.83 |
| 4 | 7.41 | 4 | 7.31 | 4 | 7.41 | 4 | 7.45 | 4 | 7.80 |
| 5 | 7.51 | 5 | 7.56 | 5 | 7.41 | 5 | 7.46 | 5 | 7.76 |
| 6 | 7.46 | 6 | 7.55 | 6 | 7.45 | 6 | 7.48 | 6 | 7.83 |
| 7 | 7.36 | 7 | 7.38 | 7 | 7.38 | 7 | 7.41 | 7 | 7.70 |
| 8 | 7.51 | 8 | 7.61 | 8 | 7.39 | 8 | 7.38 | 8 | 7.72 |
| 9 | 7.48 | 9 | 7.63 | 9 | 7.43 | 9 | 7.50 | 9 | 7.78 |
| 10 | 7.48 | 10 | 7.51 | 10 | 7.46 | 10 | 7.50 | 10 | 7.73 |
| Std dev | 0.05 | Std dev | 0.15 | Std dev | 0.08 | Std dev | 0.06 | Std dev | 0.06 |
| Ave. | 7.46 | Ave. | 7.57 | Ave. | 7.46 | Ave. | 7.47 | Ave. | 7.77 |

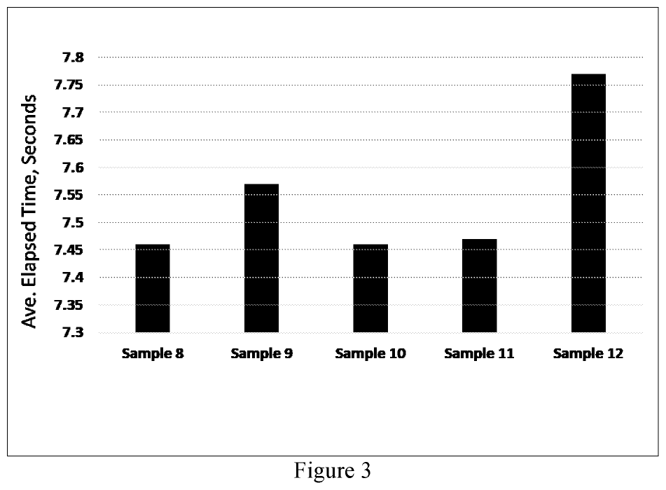

FIG. 3 shows a plot of the average elapsed times obtained as the results of the flowability data. As shown in Table 5 and FIG. 3, the results indicate that the seeds coated with a composition containing modified starches (i.e., samples 9, 10, and 11) had average flowability times comparable to that of seeds coated with a composition containing synthetic polymer (sample 8). The results also indicate that seeds coated with a composition containing modified starches (i.e., samples 9, 10, and 11) had significantly better flowability (e.g., provided lower average flowability times) compared to the seeds coated with a composition containing unmodified starch (sample 12).

### Example 2: Soy Seed Coating

A commercially available active ingredient blend commonly used in seed coating compositions is set forth in Table 6 (hereinafter “Active Ingredient Blend II”). The Active Ingredient Blend II described in Table 6 is used in the soy seed coating compositions described in this Example.

TABLE 6
Active Ingredient Blend II

| Active Ingredients | Function | Grams/45.36 kg Seed |
|---|---|---|
| Acceleron ® DX-309 fungicide | Fungicide | 6.0 |
| (Metalaxyl, 28.35%) | | |
| (Bayer, St. Louis, MO) | | |
| Acceleron ® IC-609 Insecticide | Fungicide | 66.8 |
| (Clothianidin, 48%) | | |
| (Bayer, St. Louis, MO) | | |

Seeds used to prepare Table 7 coated seeds: Soy seeds, Asgrow® AG27X0 (Montsanto).

Colorant: Chromatint® Red 40 (Chromatech, Inc., Canton, Mich.).

Coating materials: Commercially available Precise 1006 synthetic polymer binder (saxagliptin hydrochloride/dapagliflozin propanediol polymer) (Bayer Crop Science, Research Triangle Park, N.C.). Commercially available starches: liquid cationic starch, Amylopectin, 2-hydroxy-3-(trimethlylammonio) propyl ether chloride; liquid modified starch, dextrinized hydrogen octenylbutanediote (an octenyl succinate (OSA) modified starch), hydrogen octenylbutanediote (an octenyl succinate (OSA) modified starch); liquid modified starch, Amylopectin and Acid hydrolyzed, 2-hydroxypropyl ether (hydroxy propyl (PO) modified starch); low DE corn syrup (Ingredion, Westchester, Ill.).

Method for Preparing Table 7 Coated Seeds: The Active Ingredient Blend II shown in Table 6 was prepared by mixing the active ingredients together. Seed coating composition was subsequently prepared by combining 72.8 g/45.36 kg seed of the Active Ingredient Blend II with 7.9 g/45.36 kg seed of Chromatint® Red 40, 29.6 g/45.36 kg seed of water, and 90.7 g/45.36 kg seed of a coating material set forth hereinabove. Each batch of 2.25 kg seeds as shown in Table 7 was coated using Hege 11 seed coater (Wintersteiger Inc.). For each batch of 2.25 kg seeds, 30 g of the seed coating composition was used for seed coating.

TABLE 7

| Sample | Seed Coating Compositions | Batch size |
|---|---|---|
| 13 | Active Ingredient Blend II, Chromatint ® Red 40, | 2.25 kg |
| | water, and Precise 1006 synthetic polymer | |
| 14 | Active Ingredient Blend II, Chromatint ® Red 40, | 2.25 kg |
| | water, and OSA modified starch | |
| 15 | Active Ingredient Blend II, Chromatint ® Red 40, | 2.25 kg |
| | water, and PO modified starch | |
| 16 | Active Ingredient Blend II, Chromatint ® Red 40, | 2.25 kg |
| | water, and blend of OSA modified and PO modified | |
| | starches | |
| 17 | Active Ingredient Blend II, Chromatint ® Red 40, | 2.25 kg |
| | water, and blend of OSA modified, PO modified | |
| | and low DE corn syrup starches | |

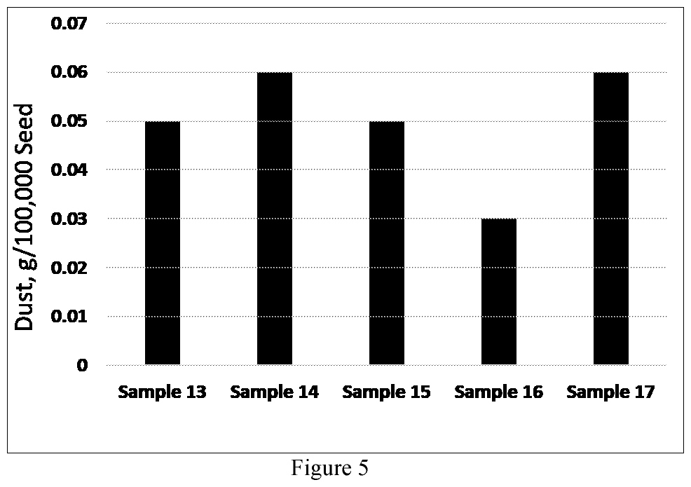

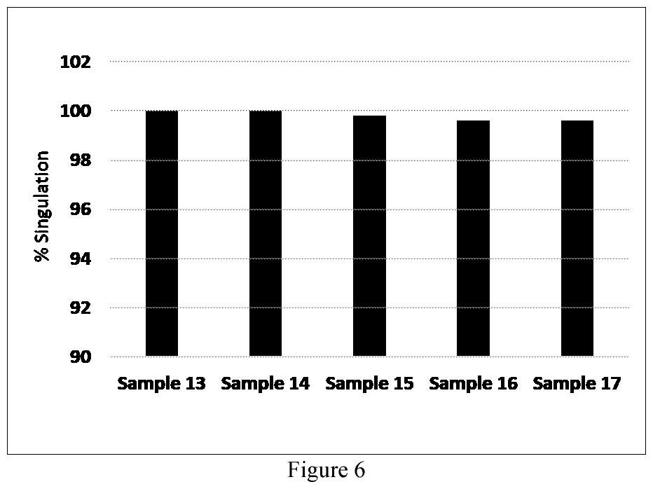

Dust Off and Plantabilitv of Coated Soy Seeds. Analyses to assess dust off and plantability properties of coated soy seeds were performed using methods as described in Example 1. The results of the dust off analysis are presented in FIG. 5, and the results of the plantability tests are presented in FIG. 6. As shown in FIG. 5, all coated seed samples provided very low levels (≤0.06 g/100,000 seeds) of dust as compared to coated soy seeds. FIG. 6 shows that all coated soy seed samples provided comparable levels of plantability (% singulation).

### Example 3: Seed Coatings with Plasticizers

A commercially available active ingredient blend commonly used in seed coating compositions is set forth in Table 8 (hereinafter “Active Ingredient Blend III”). It is considered that this Active Ingredient Blend III provides for delivery of high amounts of active ingredients to the seeds, compared to Active Ingredient Blends I and II. Active Ingredient Blend III provides for delivery of active ingredients in an amount of about 1100 ug/seed and for delivery of a high level of clothianidin, in an amount of about 710 ug/seed, though the levels of clothianidin delivered can be adjusted to between 600-1250 ug/seed.

TABLE 8
Active Ingredient Blend III

| Active Ingredients | Function | Grams/45.36 kg Seed |
|---|---|---|
| Acceleron ® DX-309 fungicide | Fungicide | 22.2 |
| (Metalaxyl, 28.35%) | | |
| (Bayer, St. Louis, MO) | | |
| Acceleron ® IC-609 Insecticide | Insecticide | 236.6 |
| (Clothianidin, 48%) | | |
| (Bayer, St. Louis, MO) | | |
| CruiserMaxx ®; Thiamethoxam, | Insecticide and | 94.6 |
| 20.80% Mefenoxam, 3.13%, | Fungicide | |
| Fludioxonil, 1.04% | | |
| Sedaxane, 1.04% (Syngenta) | | |

Seeds used to prepare Table 8 coated seeds: Corn seeds, Variety S-2338 (Ingredion Inc., Westchester, Ill.).

Colorant: Chromatint® Red 40 (Chromatech, Inc., Canton, Mich.).

Coating materials: Commercially available Precise 1006 synthetic polymer binder (saxagliptin hydrochloride/dapagliflozin propanediol polymer) (Bayer Crop Science, Research Triangle Park, N.C.). Commercially available starches: liquid cationic starch, Amylopectin, 2-hydroxy-3-(trimethlylammonio) propyl ether chloride; liquid modified starch, dextrinized hydrogen octenylbutanediote (an octenyl succinate (OSA) modified starch), hydrogen octenylbutanediote (an octenyl succinate (OSA) modified starch); liquid modified starch, Amylopectin and Acid hydrolyzed, 2-hydroxypropyl ether (hydroxy propyl (PO) modified starch).

Plasticizers: Glycerol (Rita, Crystal Lake, Ill.); titanium oxide (Brenntag, Plainfield, Ill.); low DE corn syrup (Ingredion, Westchester, Ill.); and sorbitol (Ingredion, Westchester, Ill.).

Emulsifier: Tween 80 (Croda, Inc., Edison, N.J.).

Pigment: Titanium dioxide (Brenntag, Plainfield, Ill., USA).

Method for Preparing Table 9 Coated Seeds: The Active Ingredient Blend III as shown in Table 8 was prepared by weighing and mixing the components well to form high active ingredients corn seed coating slurry. Each seed coating composition was subsequently prepared by combining 353.4 g/45.36 kg seed of the Active Ingredient Blend III with 7.9 g/45.36 kg seed of Chromatint® Red 40, 68 g/45.36 kg seed of water, and 148 g/45.36 kg seed of each coating material set forth hereinabove.

Hege 11 seed coater (Wintersteiger Inc, Ankeny, Iowa, USA) was used to treat corn seeds. For each 2.25 kg batch of seeds, 30 g seed coating composition described above was used for coating the seeds. The treater was run for 45 seconds.

TABLE 9

| Sample | Seed Coating Compositions | Batch size |
|---|---|---|
| 18 | Active Ingredient Blend III and OSA modified | 2.25 kg |
| | starch with Titanium dioxide, Glycerol and | |
| | Tween 80 | |
| 19 | Active Ingredient Blend III and OSA modified | 2.25 kg |
| | starch and Glycerol | |
| 20 | Active Ingredient Blend III and PO modified | 2.25 kg |
| | and OSA modified starch with Glycerol | |
| 21 | Active Ingredient Blend III and PO modified | 2.25 kg |
| | and OSA modified starch with Glycerol and | |
| | corn syrup | |
| 22 | Active Ingredient Blend III and PO modified | 2.25 kg |
| | and OSA modified starch with Sorbitol | |
| 23 | Active Ingredient Blend III and Precise | 2.25 kg |
| | 1006 synthetic polymer | |
| 24 | Uncoated Seeds | 2.25 kg |

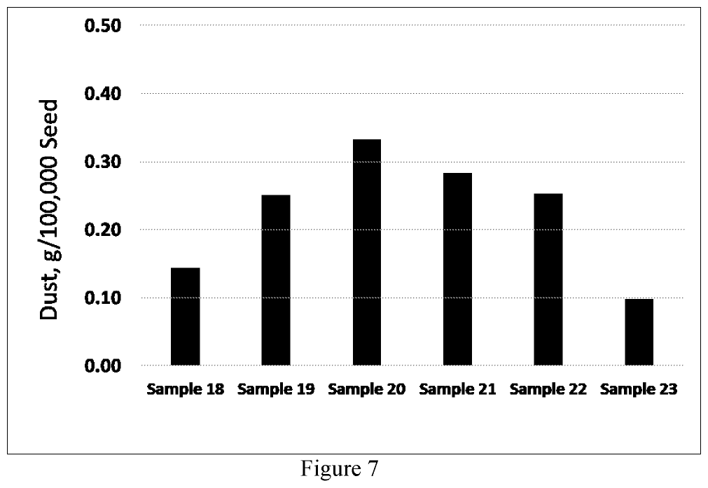

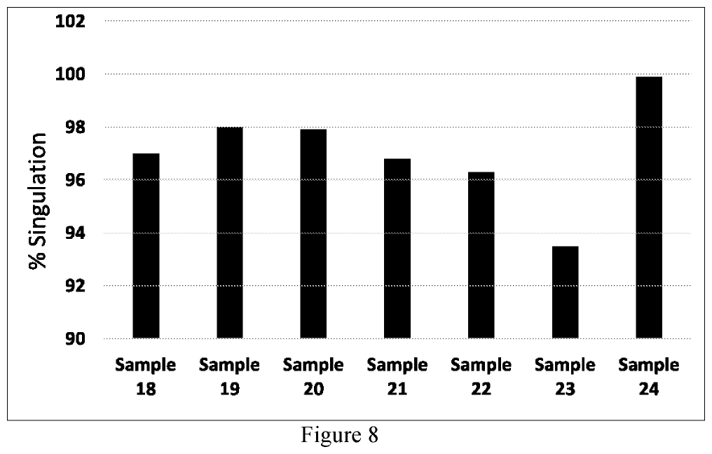

Dust Off and Plantabilitv of Corn Seeds with Plasticizers Analyses to assess dust off and plantability properties of coated corn seeds were performed as described in Example 1, except that 30±0.6° C. temperature and 78-79% relative humidity conditions were used. These parameters were chosen to simulate worst-case conditions in plantability in the field. It should be noted that talc/graphite lubricant is typically used by farmers, but was not used in this Example. The results of the dust off analysis are presented in FIG. 7, and the results of the plantability tests are presented in FIG. 8.

As shown in FIG. 7, sample 18 (OSA modified starch) and sample 23 (synthetic polymer) gave comparable results. All other samples provided relatively higher levels of dust-off, though all other samples (sample 19-22) provided dust-off levels considered acceptable within industry standards (e.g., European Seed Trade Association (ESTA), which specifies standard acceptable limits of dust-dust at ≤0.75 g/100,000 seeds. As shown in FIG. 8, and as expected, the uncoated seeds (sample 24) showed the highest degree of % singulation (≥99%). All samples, except the un-coated sample (sample 24) showed relatively lower % singulation (≤99% acceptable value) than the uncoated seeds. The reason for the low % singulation in these samples was because they were tested at a worst case scenario approximating extreme environmental conditions at high temperature (30±0.6° C.) and at high humidity (78-79%), without using talc/graphite lubricant. Surprisingly, sample 23 (with a seed coating containing synthetic polymer) provided the relatively lowest (93.5%) % singulation compared to all other coated samples in FIG. 8.

It is to be understood that the foregoing description is intended to illustrate, and not limit the scope of the scope of the appended claims. Other embodiments, advantages, and modifications are within the scope of the following claims. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. An aqueous seed coating composition comprising: a binder comprising a modified starch, and an active ingredient; and
optionally, wherein the modified starch comprises amylose, amylopectin, or any combination thereof.

2. The composition of claim 1, wherein the modified starch is from a cereal, a tuber, a root, a legume, fruit, or any combination thereof; and
optionally, wherein the modified starch is from corn, pea, potato, sweet potato, banana, barley, wheat, rice, sago, amaranth, tapioca, arrowroot, canna, or sorghum, waxy or high amylose varieties thereof, or any combination thereof.

3. The composition of claim 1, wherein the modified starch is etherified, oxidized, methylated, ethylated, propylated, alkoxylated, carboxymethylated, cationic, esterified, acylated, succinated, propylated and phosphate cross-linked, dextrinized, or any combination thereof;
optionally, wherein the modified starch has been hydrolyzed by acid, enzyme, oxidant, and/or physically to reduce molecular weight;
optionally, wherein the modified starch is acid hydrolyzed-2-hydroxypropyl ether, dextrinized hydrogen octenyl butanedioate, acetate hexadioate, 2-hydroxyl; and
optionally, wherein the modified starch is waxy, 100% amylopectin, naturally anionic phosphate, pregelatinized, or any combination thereof.

4. The composition of claim 1, wherein the active ingredient is
(i) a pesticide, a plant growth regulator, a crop desiccant, a fungicide, a bio-pesticide, a biologic containing bacterial or fungal genera, a bactericide, a bacteriostat, an insecticide, a nematicide, an insect repellant, or any combination thereof; or
(ii) a pesticide, a plant growth regulator, a crop desiccant, a fungicide, a bactericide, a bacteriostat, an insecticide, an insect repellant, a triazine, a sulfonylurea, a uracil, a urea, and organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, an acylamine fungicide, a chlorinated aromatic, a dichloro aniline fungicide, a carbamate insecticide, an organothiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, a fertilizer, a bio-pesticide from plant or microbial origin or biological live beneficial microbe from bacterial or fungal genera, or any combination thereof.

5. The composition of claim 1, further comprising a second binder, a filler, a nutrient, a wetting and dispersing additive or a pigment dispersant, a solvent, a plasticizer, an emulsifier, a thickener, a coloring agent or pigment, an anti-foaming agent, a biocide, a surfactant, mica, titanium dioxide, or any combination thereof; and
optionally, wherein the binder further comprises a synthetic polymer, an enzymatically converted starch, or a combination thereof.

6. The composition of claim 1, wherein the binder comprises up to 95 wt. % synthetic polymer, based on the weight of the binder;
optionally, wherein the composition comprises up to 99 wt. % enzymatically converted starch, based on the weight of the binder; and
optionally, wherein the composition is free of unmodified starch.

7. The composition of claim 1, wherein the binder further comprises up to 40 wt. % un-modified starch, based on the weight of the binder.

8. Use of the composition of claim 1 to coat a seed.

9. A coated seed comprising the composition of claim 1.

10. The coated seed of claim 9 wherein the seed is an agricultural seed, a vegetable seed, an herb seed, a wildflower seed, an ornamental seed, a grass seed, a tree seed, a bush seed, or any combination thereof;
optionally, wherein the seed is selected from a soybean, cotton, corn, peanut, maize, wheat, barley, oat, rye triticale, mustard, sunflower, sugar beet, safflower, millet, chicory, flax, rapeseed, buckwheat, tobacco, cannabis, hemp, alfalfa, signal grass, clover, sorghum, chick pea, bean, pea, vetch, rice, sugar cane, linseed, and any combination thereof; and
optionally, wherein the vegetable seed is selected from asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, water melon, melon, cucumber, marrow, parsley, fennel, pea, bean, radish, black salsify, eggplant, corn, carrot, onion, tomato, pepper, lettuce, cucurbit, shallot, broccoli, brassica, brussel sprout, and any combination thereof.

11. A method for coating one or more seed, comprising:
(i) admixing a binder comprising a modified starch with an active ingredient to form an aqueous seed coating composition; and
(ii) applying the composition to one or more seed; and
optionally, wherein the modified starch comprises amylose, amylopectin, or any combination thereof.

12. The method of claim 11, wherein the modified starch is from a cereal, a tuber, root, legume, fruit, or any combination thereof;
optionally, wherein the modified starch is from corn, pea, potato, sweet potato, banana, barley, wheat, rice, sago, amaranth, tapioca, arrowroot, canna, sorghum, waxy or high amylose varieties thereof, or any combination thereof.

13. The method of claim 12, wherein the modified starch has been modified through one or more of oxidation, phosphate addition, crosslinking, esterification, etherification, dextrinization, or any combination thereof; and
optionally, wherein the modified starch has been hydrolyzed by acid, enzyme, and/or oxidant to reduce molecular weight;
optionally, wherein the modified starch is waxy, 100% amylopectin, naturally anionic phosphate, pregelatinized (warm or cold water dispersible), or any combination thereof; and
optionally, wherein the modified starch is acid hydrolyzed-2-hydroxypropyl ether, dextrinized hydrogen octenyl butanedioate, acetate hexadioate, 2-hydroxyl-3-(trimethylammonio)propyl ether chloride, canary dextrin, or any combination thereof.

14. The method of claim 12, wherein the seed coating composition further comprises one or more active ingredient, wherein the active ingredient is
(i) a pesticide, a plant growth regulator, a crop desiccant, a fungicide, a bio-pesticide, a biologic containing bacterial or fungal genera, a bactericide, a bacteriostat, an insecticide, a nematicide, an insect repellant, or any combination thereof; or
(ii) a pesticide, a plant growth regulator, a crop desiccant, a fungicide, a bactericide, a bacteriostat, an insecticide, an insect repellant, a triazine, a sulfonylurea, a uracil, a urea, and organophosphonate, a nitrilo oxime fungicide, an azole imidazole fungicide, a benzimidazole fungicide, a phenylpyrrole fungicide, a phenylamide fungicide, a carboxomide fungicide, a triazole fungicide, a sulfenamide fungicide, a dithio-carbamate fungicide, a neonicotinoid insecticide, an acylamine fungicide, a chlorinated aromatic, a dichloro aniline fungicide, a carbamate insecticide, an organothiophosphate insecticide, a perchlorinated organic insecticide, a miticide, a propynyl sulfite, a triazapentadiene miticide, a chlorinated aromatic miticide, a tetradifan, a dinitrophenol miticide, a binapacryl, an adjuvant, a surfactant, a fertilizer, a bio-pesticide from plant or microbial origin or biological live beneficial microbe from bacterial or fungal genera, or any combination thereof;
optionally, wherein the seed coating composition further comprises a binder, a filler, a nutrient, a wetting and dispersing additive or a pigment dispersant, a solvent, a plasticizer, a thickener, a coloring agent or a pigment, an anti-foaming agent, a biocide, a surfactant, mica, titanium dioxide, or any combination thereof; and
optionally, wherein the binder further comprises a synthetic polymer, an enzymatically converted starch, or a combination thereof.

15. The composition of claim 14, wherein the binder comprises up to 95 wt. % synthetic polymer, based on the weight of the binder;
optionally, wherein the composition comprises up to 99 wt. % enzymatically converted starch, based on the weight of the binder;
optionally, wherein the composition is free of unmodified starch; and
optionally, wherein the binder further comprises up to 40 wt. % un-modified starch, based on the weight of the binder.
